(19) United States
(12) Patent Application Publication
(10) Pub. No.: US 2004/0223856 A1
(43) Pub. Date: Nov. 11, 2004

(54) Fuel supply pump, in particular a high-pressure fuel pump for an internal combustion engine

(75) Inventors: Helmut Rembold, Stuttgart (DE); Wolfgang Bueser, Freiberg (DE); Martin Benda, Erlenbach (DE); Bernd Schroeder, Esslingen (DE)

Correspondence Address: RONALD E. GREIGG, GREIGG & GREIGG P.L.L.C., Suite One, 1423 Powhatan Street, Alexandria, VA, 22314, US

(73) Assignee: Robert Bosch GmbH

(21) Appl. No.: 10/840,365

(22) Filed: May 7, 2004

(30) Foreign Application Priority Data
May 8, 2003 (DE) 1 03 20 592.6

(51) Int. Cl. F04B 1/26; F02D 31/00

(52) U.S. Cl. 417/222.2

(57) ABSTRACT

A high-pressure fuel supply pump for an internal combustion engine includes a pump housing and an electromagnetic actuator mechanism that can adjust the fluid quantity supplied by the fuel supply pump. The actuator mechanism is integrated into the pump housing so that a magnetic circuit of the actuator mechanism is closed by at least a region of the pump housing.

### BACKGROUND OF THE INVENTION

1. Field of the Invention

The invention relates to a fuel supply pump, in particular a high-pressure fuel pump for an internal combustion engine, with a pump housing and an electromagnetic actuator mechanism that can adjust the fluid quantity supplied by the fuel supply pump.

2. Description of the Prior Art

A fuel supply pump of the type with which this invention is concerned is known from DE 199 38 504 A1, which discloses a one-cylinder high-pressure pump for high-pressure delivery in common rail injection systems of internal combustion engines. An electromagnetic actuator mechanism can force an inlet valve of the fuel supply pump to stay open even during a delivery stroke of a piston of the fuel supply pump. To this end, a valve element of the inlet valve is acted on by a tappet of the actuator mechanism. The actuator mechanism itself is encapsulated in a separate housing.

### OBJECT AND SUMMARY OF THE INVENTION

The object of the current invention is to modify a fuel supply pump of the type mentioned above so that it can be manufactured at a lower cost and can precisely adjust the supplied fluid quantity even at high speeds of the fuel supply pump.

This object is attained by integrating the actuator mechanism into the pump housing so that a magnetic circuit of the actuator mechanism is closed by at least one region of the pump housing.

A first advantage of the fuel supply pump according to the invention is that it can be inexpensively produced because a comparatively smaller amount of material is required to produce the actuator mechanism. The reason for this is that a part of the magnetic flux that must be generated in order to electromagnetically actuate the actuator mechanism is conveyed not in the actuator mechanism itself, but in the housing of the fuel supply pump. But this has a second advantage, as well: the fuel supply pump according to the invention is smaller and therefore easier to install, for example, in an internal combustion engine.

In addition, the actuator mechanism according to the invention can achieve comparatively short switching times. Switching time is understood hereinafter to be the time in which the actuator mechanism can be moved from one switched position into another switched position. Short switching times are advantageous, for example, in internal combustion engines, which can operate at high speeds; since conventional fuel supply pumps are driven directly by the engine, high speeds of this kind leave only short intervals of time for the actuator mechanism to execute switches. Particularly problematic are the high speeds that are possible in engines with exhaust turbochargers. In these engines, speeds of up to 9000 rpm must be reckoned with. At such speeds, a high-pressure pump with a so-called triple cam, i.e. three strokes per rotation, produces a period of 4.6 ms. With the current invention, it is possible to reliably execute switches even within such a short time frame.

The short switching times result from the fact that the intimate integration of the actuator mechanism into the fuel supply pump means that only comparatively short distances have to be bridged between the generation of the electromagnetic force and the application point of this force, which translates into a lower inertia of the parts involved and in turn results in high accelerations and therefore short switching times. Incorporating the fuel supply pump housing into the closing of the magnetic circuit also permits a comparatively lossless conduction of the magnetic flux, which has a positive influence on the efficiency of the actuator mechanism and consequently also on the switching times.

In a first modification, the invention proposes that the actuator mechanism include a yoke element made of a magnetic material, which is positioned and connected to the pump housing in such a way that it at least contributes to the completion of the magnetic circuit. This modification is inexpensive and easy to manufacture.

The invention also proposes that at the end of a magnet armature oriented toward the pump housing, the actuator mechanism be provided with a connecting element for attachment to the pump housing and that at the end of the magnet armature oriented away from the pump housing, the actuator mechanism be provided with an armature counterpart; the connecting element and the armature counterpart are connected to each other by means of a sleeve element made of a nonmagnetic or dielectric material. The magnet armature is thus optimally integrated into the magnetic circuit.

In a related modification, the invention proposes that the connecting element be welded to the sleeve element, that the sleeve element be welded to the armature element, and that all three elements constitute at least part of a preassembled hydraulic assembly. The welding permits a favorable fluid-tightness and the preassembly simplifies the overall assembly of the fuel supply pump according to the invention.

In another related modification, the invention proposes that the connecting element be welded to the pump housing. This also achieves a favorable fluid-tightness of the system. For positioning here, it is advantageous if the elements are joined to one another initially by means of a press fit. It is also advantageous if the connecting element is positioned so as to set a particular opening stroke of the inlet valve when the actuating element rests against the stop.

Another embodiment provides that the armature counterpart at least indirectly constitutes a stop for an actuating element of the actuator mechanism and is connected to the dielectric sleeve in a precisely measured fashion so that it establishes the one end position of the actuating element. A precise establishment of one end position of the actuating element achieves reproducible conditions and increases precision when adjusting the delivery quantity of the fuel supply pump. The potential double function of the armature counterpart, namely conducting the magnetic flux on the one hand and limiting the movement path of the actuating element on the other, also saves material, which reduces the costs and size.

If the actuator mechanism includes a magnet coil made of brass, then the temperature influence on the switching time of the actuator mechanism can be minimized. This is because the specific resistance of brass is less dependent on temperature than, for example, that of copper.

In another advantageous modification of the fuel supply pump according to the invention, the actuator mechanism has a separate electrical assembly. This further simplifies the manufacture of the fuel supply pump since the electrical assembly can be preassembled.

In a related modification, the invention proposes that the electrical assembly be secured to the pump housing by a yoke element. This yoke element can be the one mentioned at the beginning, which serves to complete the magnetic circuit. A yoke element of this kind, while requiring little material and being easy to manufacture, assures a secure fastening of the electrical assembly.

It is particularly advantageous if the electrical assembly is prestressed in an installation position by a prestressing element. This compensates for manufacturing tolerances, which reduces production costs.

Another particularly advantageous embodiment of the fuel supply pump according to the invention is characterized in that an actuating element of the actuator mechanism engages a valve element of the fuel supply pump at a location that is off-center in relation to the valve element. This reduces the amount of force that the actuator mechanism must exert in order to actuate the valve element. When actuated by the actuating element, because of the off-center engagement, the valve element assumes an oblique position in which it is supported not only on the actuating element of the actuator mechanism, but for example also on a region oriented toward the housing. As a result, the holding forces are shared between this region oriented toward the housing on the one hand and the actuating element on the other. Consequently, the actuator mechanism can be designed to be smaller, which also results in shorter switching times.

For the case in which the actuating element presses the valve element into an open position by means of spring force when the electromagnetic actuator mechanism is without current, a smaller spring can be provided for this purpose, which further reduces the size of the actuator mechanism. Furthermore, when the actuating element is actuated, the spring forces to be overcome are not as great, which likewise has a positive influence on switching times.

In one embodiment of such an off-center engagement point, the longitudinal axis of the actuating element extends at an angle not equal to 90° in relation to a plane of the valve element. Alternatively or in addition to this, it is possible for the longitudinal axis of the actuating element to be aligned offset from the center of the valve element. Both of these embodiments are easy to produce.

The invention also proposes that two chambers adjoining the two end surfaces of a magnet armature be connected to each other via a fluid connection. This achieves a pressure relief of these chambers, which likewise permits quicker switching times.

The fluid connection can include at least one preferably spiral-shaped groove in the circumferential surface of the magnet armature. A spiral-shaped groove of this kind does not influence the symmetry of the magnet armature or if so, only does so to an insignificant degree.

Analogously, the invention proposes that the sides of the connecting element oriented toward the pump housing and the magnet armature be connected to each other via a fluid connection. This can be achieved, for example, by providing a number of axial bores in the connecting element.

Another embodiment of the fuel supply pump according to the invention provides that the actuator mechanism have a first stop element that is fastened by means of a spot weld and is contacted by an end of an actuating element of the actuator mechanism oriented away from an inlet valve of the fuel supply pump during the movement of the actuating element. This further increases the precision in the establishment of the end position of the actuating element since a material with correspondingly optimal properties can be selected for the stop element. An easily produced spot weld for the attachment is sufficient to absorb stopping forces.

The actuator mechanism can also include a second stop element that is integrated into a guide of an actuating element of the actuator mechanism and limits the stroke of the actuating element in the direction of an inlet valve of the fuel supply pump. It is thus possible to also precisely set this end position of the actuating element without incurring significant additional costs.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 is a schematic depiction of components of an internal combustion engine with a fuel supply pump and an actuator mechanism;

FIG. 2 is a partial section through a first exemplary embodiment of the fuel supply pump and the actuator mechanism from FIG. 1;

FIG. 3 is a partial section through a hydraulic assembly of the actuator mechanism from FIG. 2;

FIG. 4 is a section through an electrical assembly of the actuator mechanism from FIG. 2;

FIG. 5 is a perspective depiction of a magnet armature of the hydraulic assembly from FIG. 3;

FIG. 6 is a perspective depiction of a connecting element of the hydraulic assembly from FIG. 3;

FIG. 7 is a depiction similar to FIG. 2 of a modified exemplary embodiment;

FIG. 8 is a depiction similar to FIG. 2 of another modified exemplary embodiment;

FIG. 9 is a depiction similar to FIG. 2 of yet another embodiment;

FIG. 10 is a partial section through a hydraulic assembly of the actuator mechanism from FIG. 9;

FIG. 11 is a section through an electrical assembly of the actuator mechanism from FIG. 9;

FIG. 12 is a perspective depiction of the magnet armature of the hydraulic assembly from FIG. 10;

FIG. 13 is a perspective depiction of a connecting element of the hydraulic assembly from FIG. 10;

FIG. 14 is a partial section through a part of the assembly from FIG. 10 in order to explain the assembly process;

FIG. 15 is a depiction similar to FIG. 9 of a modified exemplary embodiment; and

FIG. 16 is a depiction similar to FIG. 9 of another modified exemplary embodiment.

### DESCRIPTION OF THE PREFERRED EMBODIMENTS

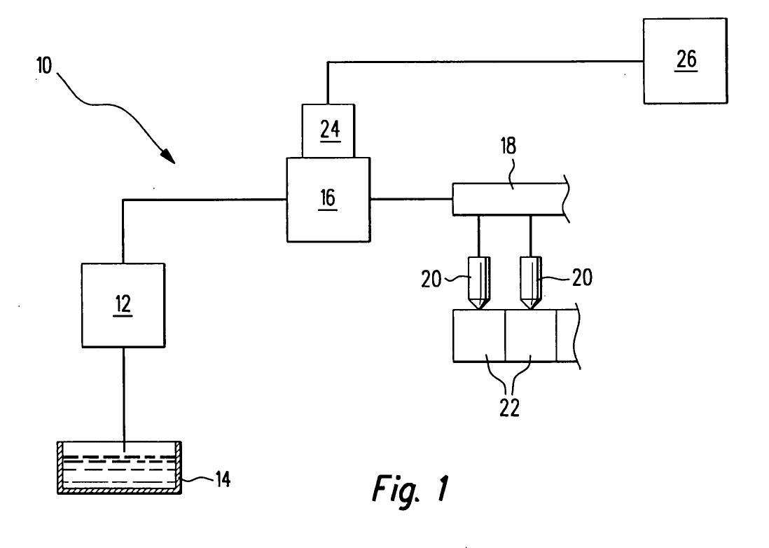

In FIG. 1, an internal combustion engine labeled as a whole with reference numeral 10 includes a presupply pump 12 that feeds the fuel from a tank 14 to a high-pressure pump 16. The latter compresses the fuel to a very high pressure and feeds it to a fuel accumulator line 18 in which the fuel is stored at a high pressure. The fuel accumulator line 18 is connected to a number of fuel injector devices 20 that inject the fuel directly into associated combustion chambers 22.

The high-pressure pump 16 is driven directly by a camshaft of the internal combustion engine 10 in a known manner not shown in FIG. 1. It is a one-cylinder piston pump and will be explained in further detail below. An electromagnetic actuator mechanism 24 for adjusting the delivery quantity of the high-pressure pump 16 is attached to the high-pressure pump 16 and is controlled by a control and regulating unit 26.

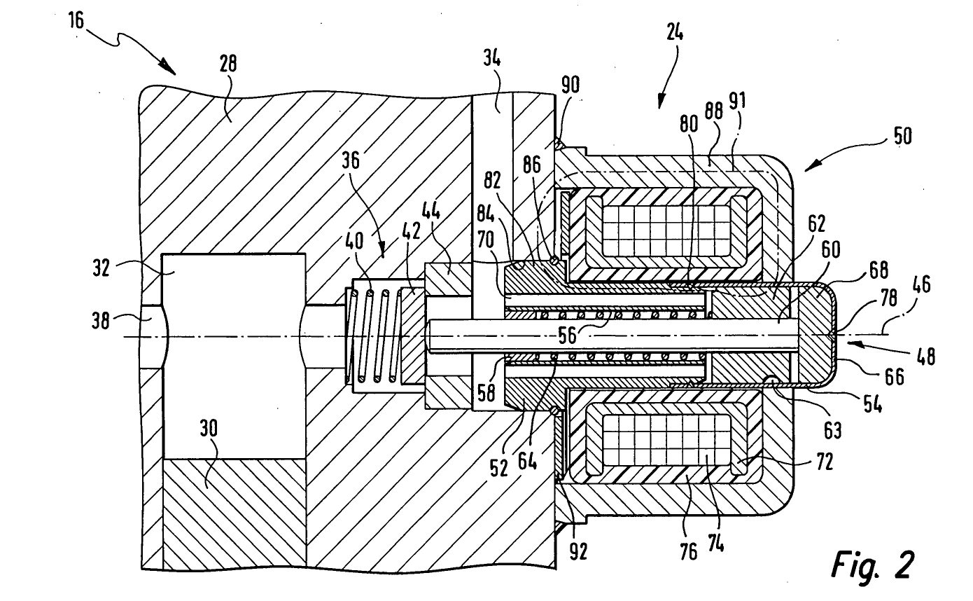

Components particularly relevant to the current case will now be explained in conjunction with FIGS. 2 to 6:

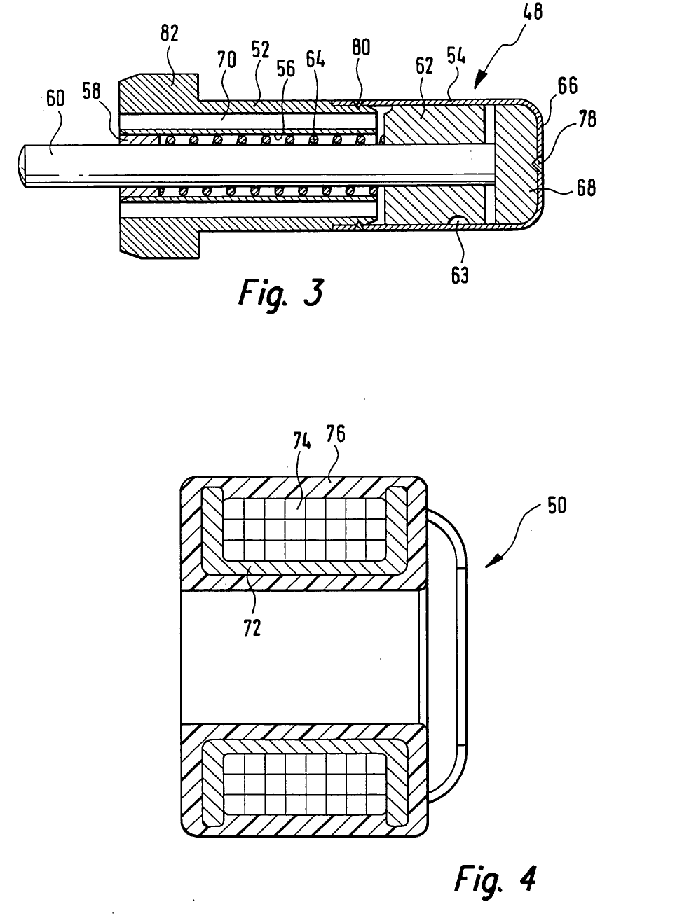

The high-pressure pump 16 has a pump housing 28 that contains a delivery piston 30 that can move back and forth in a reciprocating fashion. The delivery piston 30 delimits a delivery chamber 32 into which the fuel flows via an inlet 34 and an inlet valve 36 during an intake stroke of the delivery piston 30. An outlet conduit 38 leads from the delivery chamber 32 to an outlet valve, not shown, and from there, leads to the fuel accumulator line 18. The inlet valve 36 is a spring-loaded check valve with the valve spring 40, a disk-shaped valve element 42, and an annular valve seat 44. In the exemplary embodiment shown in FIG. 2, the actuator mechanism 24 is disposed coaxial to a center axis 46 of the valve element 42. The mechanism includes a hydraulic assembly 48 (see FIG. 3) and an electrical assembly 50 (see FIG. 4).

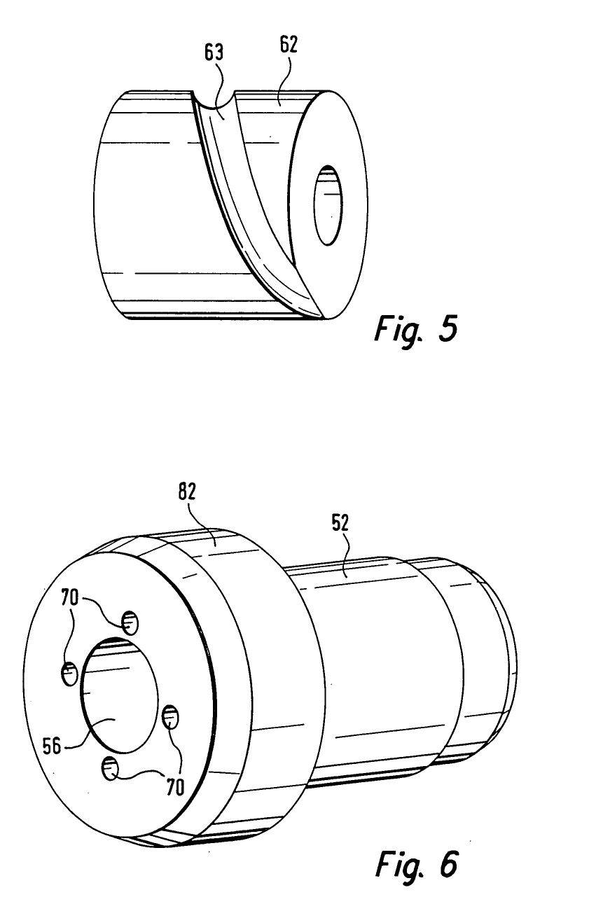

The hydraulic assembly 48 includes a tubular connecting element 52 (see FIG. 6), whose end oriented away from the inlet valve 36 in the installed position has a sleeve element 54 slid onto it with a press fit. At the end oriented toward the inlet valve 36 in the installed position, a longitudinal bore 56 of the connecting element 52 receives a guide ring 58 with a press fit, which ring guides a tappet-like actuating element 60. The actuating element 60 extends beyond the connecting element 52 at both ends. In its end region oriented away from the inlet valve 36, a cylindrical magnet armature 62 (see FIG. 5) is slid onto it and likewise fastened with a press fit. As shown in FIG. 5, the outer circumferential surface of the magnet armature 62 is provided with a spiral-shaped groove of 63 that leads from one end surface of the magnet armature 62 to the opposite end surface. A compression spring 64 is clamped between the magnet armature 62 and the guide ring 58.

The end of the sleeve element 54 oriented away from the connecting element 52 is closed by a cap region 66. The sleeve element 54 contains a disk-shaped stop part 68 in the immediate vicinity of the cap region 66. The end of the actuating element 60 pointing away from the inlet valve 36 protrudes slightly beyond the magnet armature 62. As a result, in the inactive position shown in FIGS. 2 and 3, the compression spring 64 presses the actuating element 60 against the stop part 68. The connecting element 52 contains longitudinally extending bores 70 that fluidically connect the two ends (unnumbered) of the connecting element 52 to each other.

The electrical assembly 50 (FIG. 4) includes a coil holder 72 and a magnetic coil 74. The winding of the magnetic coil 74 is made of brass. The coil holder 72 and magnetic coil 74 are extrusion coated with plastic 76. The electromagnetic actuator mechanism 24 is integrated into the high-pressure pump 16 in the following manner:

First, the hydraulic assembly 48 is preassembled. To accomplish this, the magnet armature 62 is joined to the actuating element 60, which is then inserted into the longitudinal bore 56 of the connecting element 52. Then, the compression spring 64 is slid onto the actuating element 60 and then the guide ring 58 is inserted into the longitudinal bore 56. Finally, the guide ring 58 is correspondingly positioned in order to set the spring force of the compression spring 64. Then the stop part 68 is inserted into the sleeve element 54 and fastened by means of a spot weld 78. The sleeve element 54 is then slid onto the connecting element 52 by a precise distance so as to limit the possible stroke of the actuating element 60 to a desired amount. A press fit is provided between the connecting element 52 and the sleeve element 54.

In addition, these two parts are also connected to each other by means of a weld 80. It is clear from the drawings that the magnet armature 62 is guided in the sleeve element 54 at one end and can strike against the connecting element 52 at the other end. In order to reduce wear, a chrome layer (not shown) is therefore provided in appropriate locations on the magnet armature 62 and on the connecting element 52. This chrome layer also produces an axial residual air gap between these two elements.

After the inlet valve 36 is installed in the pump housing 28, the preassembled hydraulic assembly 48 is fastened to the pump housing 28. To accomplish this, a connection region 82 of the connecting element 52 is positioned with a press fit in a receiving opening 84 of the pump housing 28 in such a way that when the actuating element 60 is actuated, this produces a desired opening movement of the valve element 42 of the inlet valve 36 and when the actuating element 60 is not actuated, the inlet valve 36 is closed. In this connection, is clear that the opening stroke of the valve element 42 of the inlet valve 36 is largely determined by the maximal permissible hydraulic flow force acting on the valve element 42 during operation. In order to assure the seal in relation to the outside, the connecting element 52 is then welded to the pump housing 28 by means of a weld 86.

The likewise preassembled electrical assembly 50 is now slid onto the hydraulic assembly 48. Then a yoke-shaped fastening element 88 is slid onto the electrical assembly 50 and is welded (reference numeral 90) to the pump housing 28. The yoke-shaped fastening element 88 is made of a material that has magnetic properties. The same is also true for the pump housing 28. During operation, the connecting element 52, the magnet armature 62, the yoke-shaped fastening element 88, and the pump housing 28 thus constitute a closed magnetic circuit 91 (indicated in FIG. 2 by a dot-and-dash line). A spring element 92 is clamped between the electrical assembly 50 and the pump housing 28 in order to compensate for both tolerances and thermal expansion.

The high-pressure pump 16 and the actuator mechanism 24 function as follows:

When the magnetic coil 74 is without current, the actuating element 60 is disposed in the end position depicted in FIG. 2, in which it rests against the stop part 68. In this state, the position of the valve element 42 of the inlet valve 36 is influenced solely by the pressure difference between the delivery chamber 32 and the inlet 34. Consequently, the maximal possible fuel quantity is delivered by the high-pressure pump 16 with each delivery stroke of the delivery piston 30. If a smaller fuel quantity is to be delivered per delivery stroke, then the magnetic coil 74 is excited during a delivery stroke. As a result, a force is generated in the magnet armature 62, which acts on the actuating element 60 in opposition to the force of the compression spring 64, the valve spring 40, and the hydraulic forces acting on the valve element 42. As a result, the inlet valve 36 is also kept open at least part of the time during a delivery stroke so that the fuel is fed not to the fuel accumulator line 18, but back to the inlet 34.

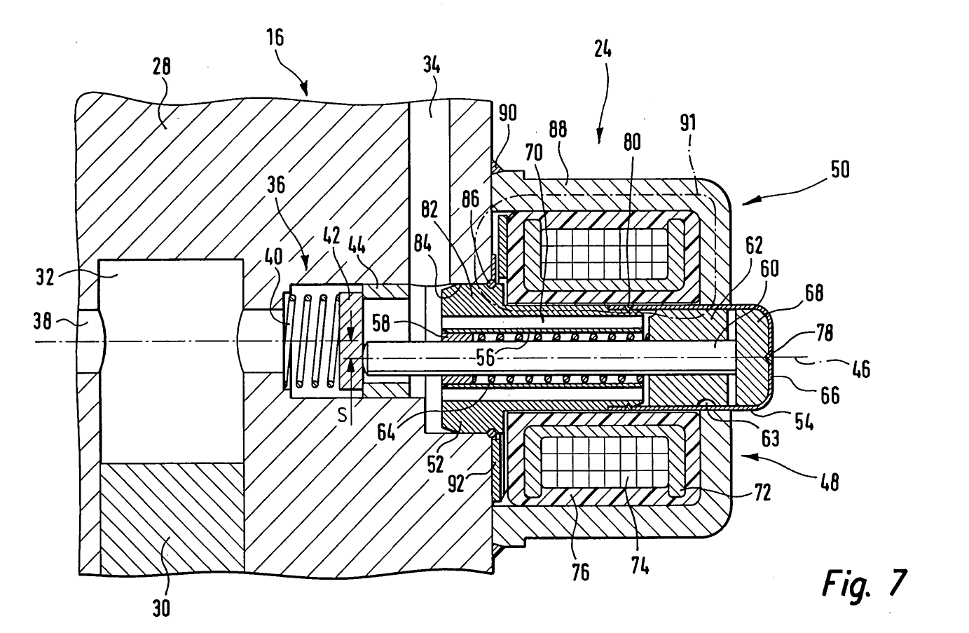

FIG. 7 shows an alternative embodiment of a high-pressure pump 16. Elements and regions that have functions equivalent to elements and regions of the high-pressure pump shown in FIGS. 2 to 6 are provided with the same reference numerals. They will not be explained in further detail.

By contrast to the preceding exemplary embodiment, the receiving opening 84 for the electromagnetic actuator mechanism 24 is not disposed coaxial to the center axis of the valve element 42, but is laterally offset from it by the distance S. Consequently, the actuating element 60 engages the valve element 42 of the inlet valve 36 off center. When the magnetic coil 74 is excited, this causes the valve element 42 to be opened obliquely and in its forced-open position, the valve element 42 rests against the actuating element 60 on the one hand and against the annular valve seat 44 on the other.

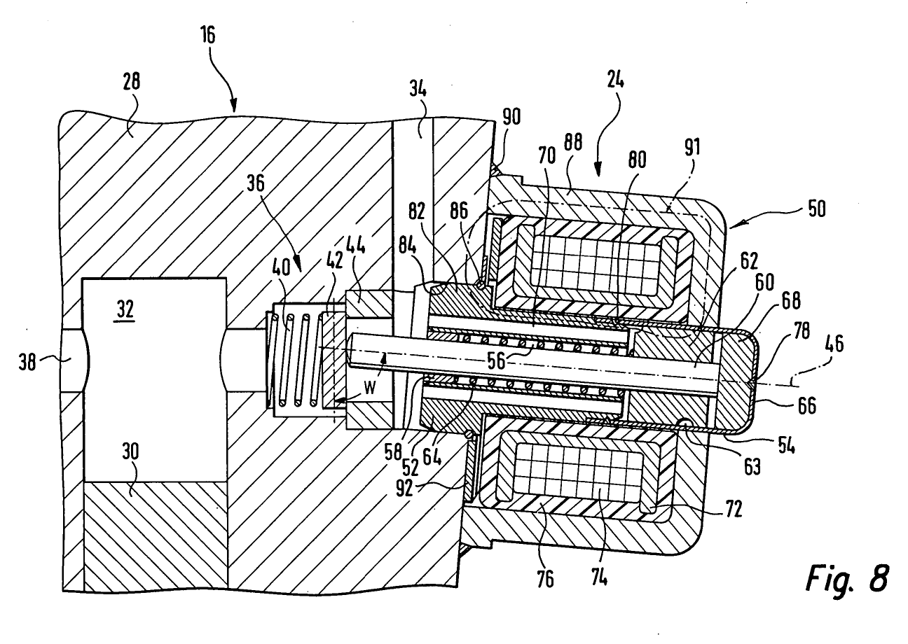

The embodiment depicted in FIG. 8 is intended to produce this same result. Here, too, elements and regions that are functionally equivalent to elements and regions of the exemplary embodiments shown in FIGS. 2 to 7 are provided with the same reference numerals and are not explained in further detail. In the exemplary embodiment shown in FIG. 8, the longitudinal axis of the actuating element 60 is disposed at an angle W that is not equal to 90° in relation to a plane in which the valve element 42 lies when closed. This also produces an off-center engagement point of the actuating element 60 against the valve element 42 of the inlet valve 36.

In the high-pressure pumps 16 shown in FIGS. 2 to 8, the electromagnetic actuator mechanism 24 was embodied so that when the magnetic coil 74 was not excited, i.e. without current, the position of the valve element 42 of the inlet valve 36 was not influenced by the electromagnetic actuator mechanism 24. An electromagnetic actuator mechanism 24 of this kind is also referred to as “currentless closed”.

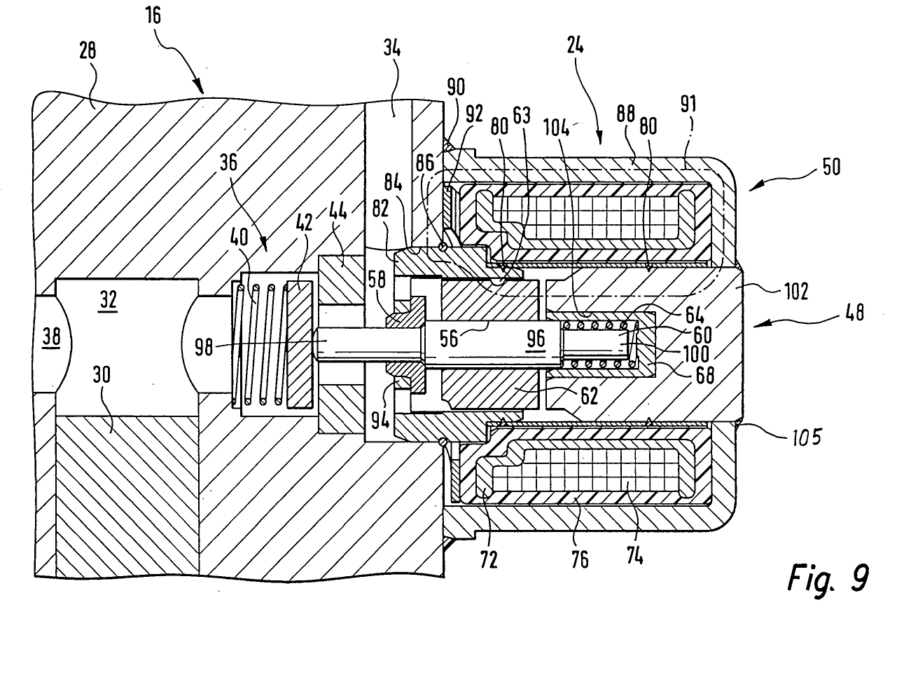

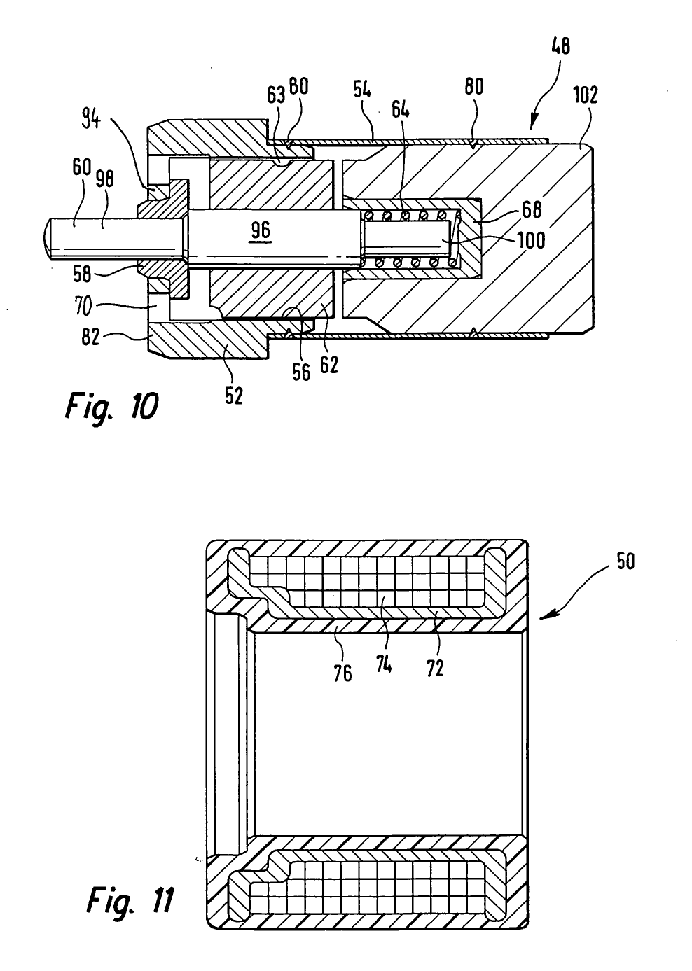

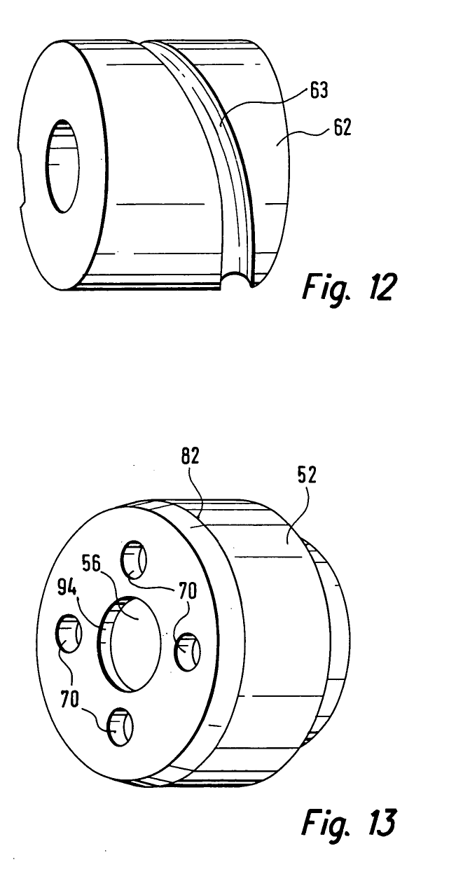

Exemplary embodiments of high-pressure pumps 16 will be explained below in conjunction with FIGS. 9 to 15, in which the actuator mechanism 24 is “currentless open”, i.e. the actuating element 60 pushes the valve element 42 of the inlet valve 36 into the open position when the magnetic coil 74 is not excited. Here, too, elements and regions that have functions equivalent to elements and regions of the exemplary embodiments shown in FIGS. 2 to 8 are provided with the same reference numerals and are not explained in further detail.

It should first be noted that the end of the connecting element 52 oriented toward the inlet valve 36 is provided with a collar 94 that extends radially inward and supports the guide ring 58. By contrast with the preceding exemplary embodiments, in the high-pressure pump 16 shown in FIG. 9, the actuating element 60 also has a central section 96 that has a larger diameter than its two end sections 98 and 100. At the end of the magnet armature 62 oriented away from the inlet valve 36, there is a cylindrical armature counterpart 102 that is welded to the sleeve element 54. The end 100 of the actuating element 60 oriented away from the inlet valve 36 is received in a blind hole 104 of the armature counterpart 102 into which a cup-shaped stop part 68 has been inserted.

A compression spring 64 that acts in the opening direction of the inlet valve 36 is clamped between the stop part 68 and a shoulder (unnumbered) formed between the end section 100 and the central section 96 of the actuating element 60. In the exemplary embodiment shown in FIG. 9, the yoke-shaped fastening element 88 is welded (reference numeral 105) directly to the armature counterpart 102. Consequently, the magnetic circuit 91 is closed by the armature counterpart 102, the yoke-shaped fastening element 88, the pump housing 28, the connecting element 52, and the magnet armature 62. Since the sleeve element 54, as in the preceding exemplary embodiments, is made of a nonmagnetic material, when the magnetic coil 74 is excited, the magnetic flux is conducted solely via the magnet armature 62.

During operation of the high-pressure pump 16, the magnetic coil 74 remains excited in order to produce a maximal delivery output. If the delivery output is to be reduced, then the magnetic coil 74 is temporarily deenergized. As a result, the compression spring 64 moves the actuating element 60 in the opening direction, counter to the force of the valve spring 40 and counter to the hydraulic force acting on the valve element 42, which causes the valve element 42 to lift away from the valve seat 44. The guide ring 58 here functions as a stop in the opening direction and in this instance, cooperates with a stop (unnumbered) that is formed between the left end section 98 and the central section 96 of the actuating element 60.

The hydraulic assembly 48 is assembled by first fastening the guide ring 58 to the connecting element 52 and then fastening the sleeve element 54 to the connecting element 52. The stop part 68 is then press-fitted into the armature counterpart 102 and the compression spring 64 is inserted into the stop part 68. In order to adjust the axial residual air gap between the magnet armature 62 and the armature counterpart 102, the actuating element 60 must be paired with the magnet armature 62 on the one hand and the armature counterpart 102 must be paired with the stop part 68 to which it is connected.

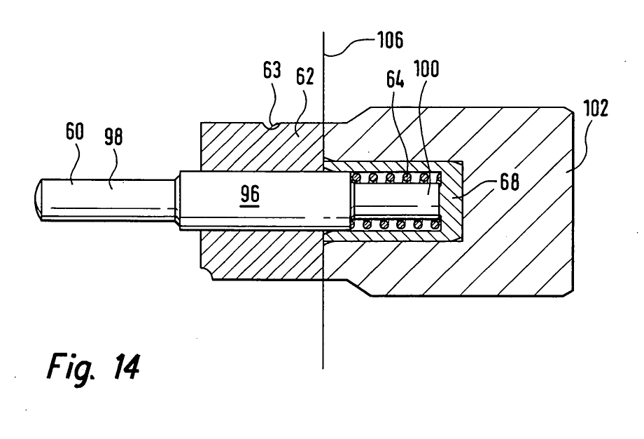

This pairing, as can also be seen in FIG. 14, can occur through the use of a spacer disk 106 that is inserted between the magnet armature 62 and the armature counterpart 102 when the magnet armature 62 is being placed onto the actuating element 60. The thickness of this spacer disk 106 then corresponds to the residual air gap. It would also be possible to measure the distance between a stop surface (unnumbered) of the stop part 68 and the corresponding surface of the armature counterpart 102 and to then join the magnet armature 62 to the actuating element 60 at a precisely measured point.

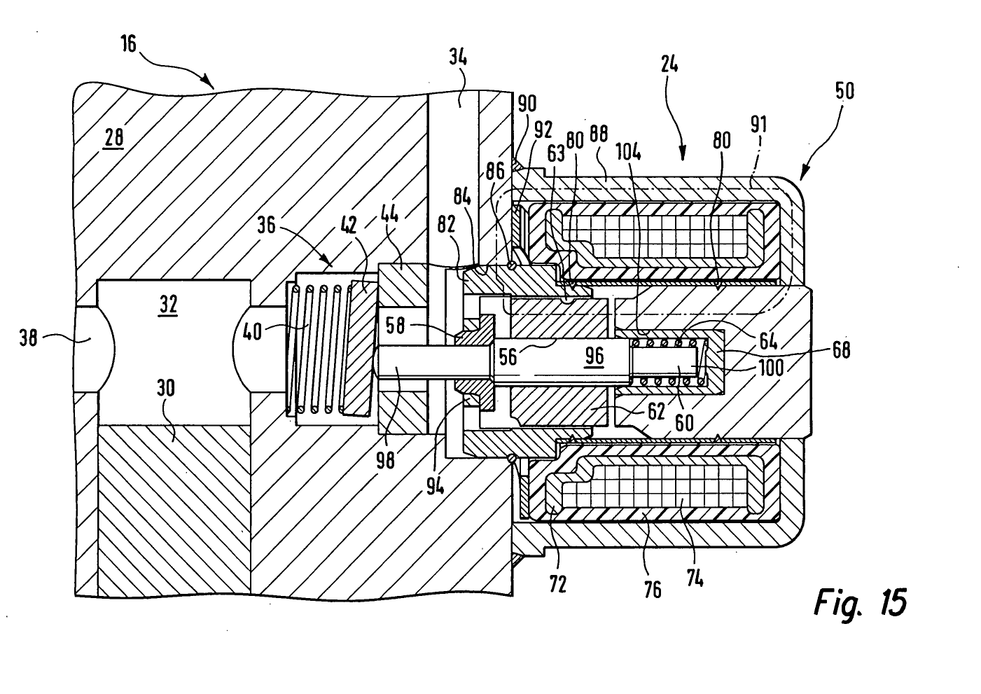

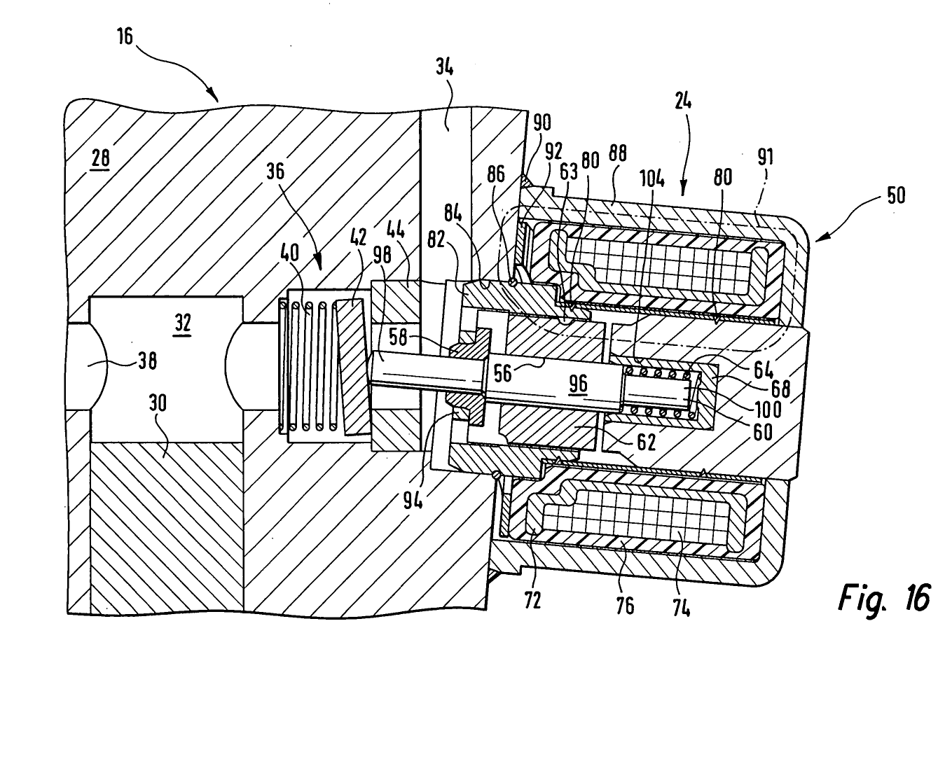

The hydraulic assembly 48 is completed by inserting the armature counterpart 102 with the actuating element 60 and the magnet armature 62 into the sleeve element 54 and by welding them to it. The armature counterpart 102 is inserted a precisely measured distance into the sleeve element 54 in order to adjust a desired stroke of the actuating element 60. The sleeve element 54 is welded as shown at 80 in a sealed fashion to the connecting element 52 at one end and to the armature counterpart 102 at the other end. Then the hydraulic assembly 48 is inserted into the corresponding receiving opening 84 in the pump housing 28 and is welded 86. Then the electrical assembly 50 is mounted and the yoke 88 is welded at 90 and 105. The modifications shown in FIGS. 15 and 16 of the high-pressure pump shown in FIG. 9 differ from it by means of the same features with which the exemplary embodiments shown in FIGS. 7 and 8 differ from the high-pressure pump 16 shown in FIG. 2. The above explanations with regard to functionally equivalent elements and regions apply accordingly.

The foregoing relates to preferred exemplary embodiments of the invention, it being understood that other variants and embodiments thereof are possible within the spirit and scope of the invention, the latter being defined by the appended claims.

We claim:

1. A high-pressure fuel supply pump (16) for an internal combustion engine (10), comprising
a pump housing (28), and
an electromagnetic actuator mechanism (24) integrated into the pump housing and operable to adjust the fluid quantity supplied by the fuel supply pump (16),
a magnetic circuit (91) of the actuator mechanism (24) being closed by at least a region of the pump housing (28).

2. The fuel supply pump (16) according to claim 1, wherein the actuator mechanism (24) comprises a yoke element (88) made of a magnetic material that is positioned and connected to the pump housing (28) so that it at least contributes to the closing of the magnetic circuit (91).

3. The fuel supply pump (16) according to claim 1, wherein, at the end of a magnet armature (62) oriented toward the pump housing (28), the actuator mechanism (24) comprises a connecting element 52 for attachment to the pump housing (28) and at the end of the magnet armature (62) oriented away from the pump housing (28), the actuator mechanism (24) comprises an armature counterpart (102), and wherein the connecting element (52) and the armature counterpart (102) are connected to each other by means of a sleeve element (54) made of a nonmagnetic or dielectric material.

4. The fuel supply pump (16) according to claim 2, wherein, at the end of a magnet armature (62) oriented toward the pump housing (28), the actuator mechanism (24) comprises a connecting element 52 for attachment to the pump housing (28) and at the end of the magnet armature (62) oriented away from the pump housing (28), the actuator mechanism (24) comprises an armature counterpart (102), and wherein the connecting element (52) and the armature counterpart (102) are connected to each other by means of a sleeve element (54) made of a nonmagnetic or dielectric material.

5. The fuel supply pump (16) according to claim 3, wherein the connecting element (52) is welded to the sleeve element (54) and the sleeve element (54) is welded to the armature counterpart (102) and all three elements (52, 54,102) constitute at least part of a preassembled hydraulic assembly (48).

6. The fuel supply pump (16) according to claim 4, wherein the connecting element (52) is welded to the sleeve element (54) and the sleeve element (54) is welded to the armature counterpart (102) and all three elements (52, 54,102) constitute at least part of a preassembled hydraulic assembly (48).

7. The fuel supply pump (16) according to claim 5, wherein the connecting element (52) is welded (86) to the pump housing (28).

8. The fuel supply pump (16) according to claim 3, wherein the armature counterpart (102) at least indirectly constitutes a stop for an actuating element (60) of the actuator mechanism (24) and is connected to the sleeve element (54) in a precisely measured fashion so that it establishes one end position of the actuating element (60).

9. The fuel supply pump (16) according to claim 1, wherein the actuator mechanism (24) comprises a magnetic coil (74) made of brass.

10. The fuel supply pump (16) according to claim 1, wherein the actuator mechanism (24) comprises a separate electrical assembly (50).

11. The fuel supply pump (16) according to claim 10, wherein the electrical assembly (50) is secured to the pump housing (28) by a yoke element (88).

12. The fuel supply pump according to claim 10, wherein the electrical assembly (50) is prestressed in the installed position by a prestressing element (92).

13. The fuel supply pump according to claim 11, wherein the electrical assembly (50) is prestressed in the installed position by a prestressing element (92).

14. The fuel supply pump (16) according to claim 1, wherein the actuator mechanism (24) comprises an actuating element (60) which engages a valve element (42) of the fuel supply pump (16) at a location that is off-center in relation to the valve element (42).

15. The fuel supply pump (16) according to claim 14, wherein the longitudinal axis of the actuating element (60) is disposed at an angle (W) that is not equal to 900 in relation to a plane of the valve element (42).

16. The fuel supply pump (16) according to claim 14, wherein the longitudinal axis of the actuating element (60) is offset from the center of the valve element (42) by the distance (S).

17. The fuel supply pump (16) according to claim 15, wherein the longitudinal axis of the actuating element (60) is offset from the center of the valve element (42) by the distance (S).

18. The fuel supply pump (16) according to claim 1, comprising two chambers adjoining the two end surfaces of a magnet armature (62) are connected to each other via a fluid connection (63).

19. The fuel supply pump according to claim 18, wherein the fluid connection comprises at least one preferably spiral-shaped groove (63) in the circumference surface of the magnet armature (62).

20. The fuel supply pump (16) according to claim 3, further comprising a fluid connection (70) connecting the ends of the connecting element (52) oriented toward the pump housing (28) and the magnet armature (62).

21. The fuel supply pump (16) according to claim 14, further comprising a fluid connection (70) connecting the ends of the connecting element (52) oriented toward the pump housing (28) and the magnet armature (62).

22. The fuel supply pump (16) according to claim 1, wherein the actuator mechanism (24) comprises a first stop element (68) that is fastened by means of a spot weld (78) and can be contacted by the end of an actuating element (60) of the actuator mechanism (24) oriented away from an inlet valve (36) of the fuel supply pump (16) during the movement of the actuating element (60).

23. The fuel supply pump (16) according to claim 1, wherein the actuator mechanism (24) comprises a second stop element (58) that is integrated into a guide of an actuating element (60) of the actuator mechanism (24) and limits the stroke of the actuating element (60) in the direction of an inlet valve (36) of the fuel supply pump (16).
